(19) United States
(12) Patent Application Publication
(10) Pub. No.: US 2024/0347786 A1
(43) Pub. Date: Oct. 17, 2024

(54) ELECTROCHEMICAL APPARATUS AND ELECTRONIC APPARATUS

(71) Applicant: Ningde Amperex Technology Limited, Ningde (CN)

(72) Inventors: Wenqiang CHENG, Ningde (CN); Kefei WANG, Ningde (CN)

(73) Assignee: Ningde Amperex Technology Limited, Ningde (CN)

(21) Appl. No.: 18/757,902

(22) Filed: Jun. 28, 2024

Related U.S. Application Data
(63) Continuation of application No. PCT/CN2021/142391, filed on Dec. 29, 2021.

(51) Int. Cl. H01M 10/42; H01M 4/02; H01M 4/131; H01M 4/62; H01M 10/0525; H01M 10/0567

(52) U.S. Cl. CPC H01M 10/4235; H01M 4/131; H01M 4/623; H01M 10/0525; H01M 10/0567; H01M 2004/028

(57) ABSTRACT

An electrochemical apparatus, including a positive electrode. The positive electrode includes a positive current collector and a positive electrode mixture layer formed on at least one surface of the positive current collector. The positive electrode mixture layer satisfies a relation: F₁/F₂≥5, where a cohesive force of the positive electrode mixture layer at an initial test temperature of 25° C. is F₁ N/m, and a cohesive force of the positive electrode mixture layer treated at 130° C. and then cooled to 25° C. is F₂ N/m. The above design not only sufficiently improves safety performance of the electrochemical apparatus at high pressure and high temperature, but also effectively reduces the voltage drop.

### CROSS REFERENCE TO RELATED APPLICATIONS

This application is a continuation application of International Application No. PCT/CN2021/142391, filed on Dec. 29, 2021, the contents of which are incorporated herein by reference in its entirety.

### TECHNICAL FIELD

This application relates to the field of energy storage, and in particular, to an electrochemical apparatus and an electronic apparatus, especially a lithium-ion battery.

### BACKGROUND

With the popularization and application of smart products, people's demand for electronic products such as a mobile phone, a notebook computer, and a camera is increasing year by year. An electrochemical apparatus serving as a power supply of the electronic products is increasingly important in our daily lives. By virtue of advantages such as a high specific energy, a high working voltage, a low self-discharge rate, a small size, and a light weight, lithium-ion batteries are widely applied in the field of consumer electronics.

However, in recent years, the safety of the lithium-ion batteries has attracted great attention due to frequent occurrence of the incidents such as explosions of electronic products caused by the lithium-ion batteries. Ensuring the safety of the lithium-ion batteries in use is a prerequisite to expanding the applications of the batteries. In addition, with the lithium-ion batteries being applied under extreme conditions, how to suppress the voltage drop of electrochemical apparatus at high temperature and high pressure and improve the high-temperature discharge performance of the electrochemical apparatus is also a hot topic of concern.

In view of this, it is necessary to provide an electrochemical apparatus and an electronic apparatus of high safety and low voltage drop at high temperature and high pressure.

### SUMMARY

This application solves the above problem in the prior art to some extent by adjusting the cohesive force of a positive electrode mixture layer.

According to one aspect of this application, this application provides an electrochemical apparatus. The electrochemical apparatus includes a positive electrode. The positive electrode includes a positive current collector and a positive electrode mixture layer formed on at least one surface of the positive current collector. The positive electrode mixture layer satisfies a relation: F₁/F₂≥5, where a cohesive force of the positive electrode mixture layer at an initial test temperature of 25° C. is F₁ N/m, and a cohesive force of the positive electrode mixture layer treated at 130° C. and then cooled to 25° C. is F₂ N/m.

According to the above embodiment of this application, 30≤F₁≤100.

According to the above embodiment of this application, the positive electrode mixture layer includes a heat-sensitive binder. The heat-sensitive binder is preferably thermally expandable microspheres.

According to the above embodiment of this application, when the temperature is in a range of 130° C. to 150° C., a viscosity of the heat-sensitive binder decreases with increase of the temperature.

According to the above embodiment of this application, based on a total mass of the positive electrode mixture layer, a mass percentage of the heat-sensitive binder is x %, satisfying:

$$0.5 \leq x \leq 5.$$

According to the above embodiment of this application, the electrochemical apparatus further includes an electrolyte solution. The electrolyte solution includes a cyano-containing compound.

According to the above embodiment of this application, based on a total mass of the electrolyte solution, a mass percentage of the cyano-containing compound is a %, satisfying:

$$0.1 \leq a \leq 15.$$

According to the above embodiment of this application, F₁/a≥2.

According to the above embodiment of this application, the cyano-containing compound includes at least one of: succinonitrile, glutaronitrile, adiponitrile, 1,5-dicyanopentane, 1,6-dicyanohexane, tetramethyl succinonitrile, 2-methyl glutaronitrile, 2,4-dimethyl glutaronitrile, 2,2,4,4-tetramethyl glutaronitrile, 1,4-dicyanopentane, 1,2-dicyanobenzene, 1,3-dicyanobenzene, 1,4-dicyanobenzene, ethylene glycol bis(propionitrile) ether, 3,5-dioxa-pimelonitrile, 1,4-bis(cyanoethoxy) butane, diethylene glycol bis(2-cyanoethyl) ether, triethylene glycol bis(2-cyanoethyl) ether, tetraethylene glycol bis(2-cyanoethyl) ether, 1,3-bis(2-cyanoethoxy) propane, 1,4-bis(2-cyanoethoxy) butane, 1,5-bis(2-cyanoethoxy) pentane, ethylene glycol bis(4-cyanobutyl) ether, 1,4-dicyano-2-butene, 1,4-dicyano-2-methyl-2-butene, 1,4-dicyano-2-ethyl-2-butene, 1,4-dicyano-2,3-dimethyl-2-butene, 1,4-dicyano-2,3-diethyl-2-butene, 1,6-dicyano-3-hexene, 1,6-dicyano-2-methyl-3-hexene, 1,3,5-pentanetricarbonitrile, 1,2,3-propanetricarbonitrile, 1,3,6-hexanetricarbonitrile, 1,2,6-hexanetricarbonitrile, 1,2,3-tris(2-cyanoethoxy) propane, 1,2,4-tris(2-cyanoethoxy) butane, 1,1,1-tris(cyanoethoxymethylene) ethane, 1,1,1-tris(cyanoethoxymethylene) propane, 3-methyl-1,3,5-tris(cyanoethoxy) pentane, 1,2,7-tris(cyanoethoxy) heptane, 1,2,6-tris(cyanoethoxy) hexane, or 1,2,5-tris(cyanoethoxy) pentane.

According to the above embodiment of this application, the cyano-containing compound includes at least two of: succinonitrile, adiponitrile, ethylene glycol bis(propionitrile) ether, 1,3,5-pentanetricarbonitrile, 1,3,6-hexanetricarbonitrile, 1,2,6-hexanetricarbonitrile, 1,2,3-tris(2-cyanoethoxy) propane, or 1,2,4-tris(2-cyanoethoxy) butane.

According to the above embodiment of this application, the electrochemical apparatus further includes an electrolyte solution. The electrolyte solution includes at least one of: fluoroethylene carbonate, 1,3-propane sultone, ethylene sulfate, vinylene carbonate, 1-propyl phosphate cyclic anhydride, or lithium difluorophosphate.

According to another aspect of this application, this application further provides an electronic apparatus. The electronic apparatus includes the electrochemical apparatus disclosed in the above embodiment.

In a case of thermal runaway, the positive electrode mixture layer used in this application can quickly obstruct the transport channel of lithium ions and electrons, terminate electrochemical reactions, control thermal runaway reactions, and significantly improve the safety performance of the electrochemical apparatus. In addition, the positive electrode mixture layer used in this application can also sufficiently suppress the voltage drop of the electrochemical apparatus during high-temperature storage.

Additional aspects and advantages of some embodiments of this application will be partly described or illustrated herein later or expounded through implementation of an embodiment of this application.

### DETAILED DESCRIPTION

Some embodiments of this application will be described in detail below. No embodiment of this application is to be construed as a limitation on this application.

Unless otherwise expressly specified, the following terms used herein have the meanings defined below.

The terms “include”, “comprise” and “contain” are used herein in an open and unrestrictive sense.

In addition, a quantity, a ratio, or another numerical value herein is sometimes expressed in the format of a range. Understandably, such a range format is set out for convenience and brevity, and needs to be flexibly understood to include not only the numerical values explicitly specified and defined by the range, but also all individual numerical values or sub-ranges covered in the range as if each individual numerical value and each sub-range were explicitly specified.

In the description of specific embodiments and claims, a list of items referred to by using the terms such as “one or more of”, “one or more thereof”, “one or more types of” or other similar terms may mean any combination of the listed items. For example, if items A and B are listed, the phrases “at least one of A and B” and “at least one of A or B” mean: A alone; B alone; or both A and B. In another example, if items A, B, and C are listed, the phrases “at least one of A, B, and C” and “at least one of A, B, or C” mean: A alone; B alone; C alone; A and B (excluding C); A and C (excluding B); B and C (excluding A); or all of A, B, and C. The item A may include a single element or a plurality of elements. The item B may include a single element or a plurality of elements. The item C may include a single element or a plurality of elements.

Through research, the applicant hereof finds that the safety of an electrochemical apparatus (for example, a lithium-ion battery) is essentially related to thermal runaway. For example, an electronic product in use is inevitably prone to be misused. For example, an electronic product may be charged all night to cause overcharge of the electrochemical apparatus. The misuse may cause the electrochemical apparatus to heat up or even get hot, thereby being very prone to induce and aggravate side reactions inside the electrochemical apparatus. The side reactions mainly include decomposition of a positive and negative active materials and reactions between the positive or negative active material and an electrolyte solution. Most of the reactions are exothermic reactions, and cause the internal temperature of the electrochemical apparatus to further increase (for example, to 120° C. and above), thereby ultimately leading to thermal runaway of the electrochemical apparatus.

To tackle this problem, a currently commonly used technology is to coat a surface of a separator of the electrochemical apparatus with a low-melting polymer. When the internal temperature of the electrochemical apparatus rises, the polymer melts and is sucked into micropores of the separator matrix by virtue of capillary action to make the separator close pores, thereby cutting off the transport channel of lithium ions, terminating charge-discharge reactions, and ensuring safety of the electrochemical apparatus during misuse. However, the disadvantage of this method is that in a case of thermal runaway, the temperature usually rises very quickly. In this case, no enough time is available at all for the polymer to melt and close pores of the separator over a large area by virtue of the capillary action, and therefore, the charge-discharge reactions cannot be terminated in time. With the continuous rise of the temperature, side reactions intensify, and the structures of the positive and negative electrodes are disrupted irreversibly, thereby reducing the thermal stability of the electrode plates drastically, and giving rise to safety hazards.

To solve the above problems, by adjusting the properties (such as cohesive force) of the positive electrode mixture layer, this application makes the positive electrode mixture layer quickly absorb heat and obstruct the electron channel when the electrochemical apparatus is thermally runaway. The design of the positive electrode disclosed in this application can greatly improve the safety performance of the electrochemical apparatus at high temperature and high pressure. In addition, the design of the positive electrode disclosed in this application can also effectively suppress the voltage drop of the electrochemical apparatus during high-temperature storage and improve the high-temperature discharge performance of the electrochemical apparatus. The following describes in detail components of the electrochemical apparatus disclosed herein.

### I. Positive Electrode

The positive electrode includes a positive current collector and a positive electrode mixture layer formed on at least one surface of the positive current collector. The positive electrode mixture layer includes a positive active material. The positive active material is any material capable of reversibly intercalating and deintercalating metal ions such as lithium ions. The positive electrode mixture layer may be one layer or a plurality of layers. Each layer in the plurality of positive electrode mixture layers may include the same or different positive active materials. In addition, the positive electrode mixture layer further includes a binder and/or a conductive agent.

A main characteristic of the positive electrode mixture layer of this application is that the positive electrode mixture layer satisfies the following relation: F₁/F₂≥5, where a cohesive force of the positive electrode mixture layer at an initial test temperature of 25° C. is F₁ N/m, and a cohesive force of the positive electrode mixture layer treated at 130° C. and then cooled to 25° C. is F₂ N/m.

The cohesive force of the positive electrode mixture layer can reflect the bonding properties between the positive active material particles in the positive electrode mixture layer, and one of the parameters that characterize the inherent properties of the positive electrode mixture layer. By controlling the cohesive force of the positive electrode mixture layer to make F₁/F₂ satisfy the above relation, in a case of thermal runaway, the bonding force between the positive active material particles is significantly lower than the bonding force at a room temperature (for example, 25° C.). In this case, the positive electrode mixture layer can obstruct the transport channel of lithium ions and electrons, and terminate electrochemical reactions, thereby effectively controlling thermal runaway reactions, and significantly improving the safety performance of the electrochemical apparatus. In addition, the applicant hereof unexpectedly finds that controlling the cohesive force of the positive electrode mixture layer to make F₁/F₂ satisfy the above relation can also effectively reduce the voltage drop of the electrochemical apparatus during high-temperature storage.

In some embodiments, F₁ and F₂ satisfy the following relation: F₁/F₂≥6. In some embodiments, F₁ and F₂ satisfy the following relation: F₁/F₂≥8. In some embodiments, F₁ and F₂ satisfy the following relation: F₁/F₂≥10. In some embodiments, the F₁/F₂ ratio is 5, 10, 15, 20, 25, 30, 35, 40, 45, 50, 55, 60, 65, 70, 75, 80, 85, 90, 95, 100, or a value falling within a range formed by any two thereof.

In some embodiments, 30≤F₁≤100. In some embodiments, 40≤F₁≤80. In some embodiments, 50≤F₁≤60. In some embodiments, F₁ is 30, 35, 40, 45, 50, 55, 60, 65, 70, 75, 80, 85, 90, 95, 100, or a value falling within a range formed by any two thereof.

In some embodiments, 6≤F₂≤20. In some embodiments, 10≤F₂≤15. In some embodiments, F₂ is 6, 8, 10, 12, 15, 18, 20, or a value falling within a range formed by any two thereof.

In some embodiments, the cohesive force of the positive electrode mixture layer may be adjusted by using a heat-sensitive binder in the positive electrode mixture layer.

In some embodiments, when the temperature is in a range of 130° C. to 150° C., a viscosity of the heat-sensitive binder decreases with the increase of the temperature. When the electrochemical apparatus is thermally runaway and the temperature rises rapidly, the heat-sensitive binder can quickly absorb heat, change in volume (for example, expand), rupture, and harden to lose viscosity or liquefy to lose viscosity, thereby greatly reducing the cohesive force of the positive electrode mixture layer, obstructing the electron transport channel, terminating electrochemical reactions, controlling thermal runaway reactions, improving the safety performance of electrochemical apparatus, and reducing the voltage drop of the electrochemical apparatus.

In some embodiments, the heat-sensitive binder includes at least one of polyethylene, polypropylene, polyethylene vinyl acetate, or polystyrene.

In some embodiments, the heat-sensitive binder includes thermally expandable microspheres. In a process of rapid temperature rise, the thermally expandable microspheres can quickly absorb heat, and expand in volume violently to greatly reduce the viscosity of the positive electrode mixture layer, thereby obstructing the electron transport channel, terminating electrochemical reactions, controlling the thermal runaway reactions, enhancing the safety performance of the electrochemical apparatus, and reducing the voltage drop of the electrochemical apparatus.

In some embodiments, in contrast to the volume of the thermally expandable microspheres at an internal temperature of 20° C. to 40° C. in the electrochemical apparatus, the volume expansion rate of the thermally expandable microspheres at an internal temperature of 130° C. or above in the electrochemical apparatus is 500% or above without rupturing. In some embodiments, in contrast to the volume of the thermally expandable microspheres at an internal temperature of 20° C. to 40° C. in the electrochemical apparatus, the volume expansion rate of the thermally expandable microspheres at an internal temperature of 130° C. or above in the electrochemical apparatus is 700% or above without rupturing. In some embodiments, in contrast to the volume of the thermally expandable microspheres at an internal temperature of 20° C. to 40° C. in the electrochemical apparatus, the volume expansion rate of the thermally expandable microspheres at an internal temperature of 130° C. or above in the electrochemical apparatus is 1000% or above without rupturing.

The thermally expandable microspheres may be obtained by incorporating a thermally expandable material into an elastic shell. The thermally expandable microspheres may be prepared by any appropriate method, such as a coagulation method or an interfacial polymerization method.

The thermally expandable materials may include, but are not limited to, propane, propylene, butene, n-butane, isobutane, isopentane, neopentane, n-pentane, n-hexane, isohexane, heptane, octane, petroleum ether, methane halide, tetraalkyl silane, or other low-boiling liquids; or azodicarbonamide vaporized by pyrolysis, or the like.

Materials that form the elastic shell include, but are not limited to, a polymer formed from at least one of the following monomers: nitrile monomers such as acrylonitrile, methacrylonitrile, α-chloroacrylonitrile, α-ethoxyacrylonitrile, and fumaronitrile; carboxylic acid monomers such as acrylic acid, methacrylic acid, itaconic acid, maleic acid, fumaric acid, and citraconic acid; vinylidene chloride; vinyl acetate; (meth)acrylate ester monomers such as methyl (meth)acrylate, ethyl (meth)acrylate, n-butyl (meth)acrylate, isobutyl (meth) acrylate, tert-butyl (meth) acrylate, isobornyl (meth) acrylate, cyclohexyl (meth) acrylate, benzyl (meth) acrylate, and β-carboxyethyl acrylate; styrene monomers such as styrene, α-methylstyrene, and chlorostyrene; and amide monomers such as acrylamide, substituted acrylamide, methacrylamide, and substituted methacrylamide. A polymer formed from such monomers may be a homopolymer or a copolymer. The copolymers include, but are not limited to, poly(vinylidene chloride-co-methyl methacrylate-co-acrylonitrile), poly(methyl methacrylate-co-acrylonitrile-co-methacrylonitrile), poly(methyl methacrylate-co-acrylonitrile), or poly(acrylonitrile-co-methacrylonitrile-co-itaconic acid), or the like.

In a process of preparing the thermally expandable microspheres, an inorganic foaming agent or an organic foaming agent may be used. The inorganic foaming agents include, but are not limited to, ammonium carbonate, ammonium bicarbonate, sodium bicarbonate, ammonium nitrite, sodium borohydride, various azides, and the like. The organic foaming agents include, but are not limited to, chlorofluorinated alkane compounds such as trichloromonofluoromethane and dichloromonofluoromethane; azo compounds such as azobisisobutyronitrile, azodicarbonamide, and barium azodicarboxylate; hydrazine compounds such as p-toluenesulfonylhydrazine, diphenylsulfone-3,3′-disulfonylhydrazine, 4,4′-oxybis(benzenesulfonyl hydrazine), and allyl bis(sulfonyl hydrazine); semicarbazide compounds such as p-toluenesulfonyl semicarbazide and 4,4′-oxybis(benzenesulfonyl semicarbazide); triazole compounds such as 5-morpholinyl-1,2,3,4-thiotriazole; N-nitroso compounds such as N,N′-dinitrosopentamethylene tetramine and N,N′-dimethyl-N,N′-dinitrosoterephthalamide, and the like.

The above thermally expandable microspheres may be a commercially available product instead. For example, the thermally expandable microspheres that are commercially available may include, but are not limited to, product “Matsumoto Microsphere” (grades: F-30, F-30D, F-36D, F-36LV, F-50, F-50D, F-65, F-65D, FN-100SS, FN-100SSD, FN-180SS, FN-180SSD, F-190D, F-260D, F-2800D) manufactured by Matsumoto Oil & Fat Pharmaceutical Co., Ltd.; product “Expancel” (grades: 053-40, 031-40, 920-40, 909-80, 930-120) manufactured by Japan Fillite Co., Ltd.; “DAIFOAM” (grades: H750, H850, H1100, S2320D, S2640D, M330, M430, M520) manufactured by Kureha Chemical Industry Co., Ltd.; and “ADVANCELL” (grades: EML101, EMH204, EHM301, EHM302, EHM303, EM304, EHM401, EM403, EM501) manufactured by Sekisui Chemical Co., Ltd.

In some embodiments, the particle size of the thermally expandable microspheres at a room temperature is 0.5 μm to 80 μm. In some embodiments, the particle size of the thermally expandable microspheres at a room temperature is 5 μm to 45 μm. In some embodiments, the particle size of the thermally expandable microspheres at a room temperature is 10 μm to 20 μm. In some embodiments, the particle size of the thermally expandable microspheres at a room temperature is 10 μm to 15 μm. In some embodiments, the average particle size of the thermally expandable microspheres at a room temperature is 6 μm to 45 μm. In some embodiments, the average particle size of the thermally expandable microspheres at a room temperature is 15 μm to 35 μm. The particle size and average particle size of the thermally expandable microspheres may be obtained by a particle size distribution measurement method among the laser scattering methods.

In some embodiments, based on a total mass of the positive electrode mixture layer, a mass percentage of the heat-sensitive binder is x %, satisfying: 0.5≤x≤5. In some embodiments, x may be 0.5, 1.0, 1.5, 2.0, 2.5, 3.0, 3.5, 4.0, 4.5, 5.0, or a value falling within a range formed by any two thereof. When the mass percentage of the heat-sensitive binder in the positive electrode mixture layer falls within the above range, the safety of the electrochemical apparatus is further improved, and the voltage drop is further reduced.

The type of the positive active material is not particularly limited herein, as long as the material can electrochemically absorb and release metal ions (such as lithium ions). In some embodiments, the positive active material containing lithium and at least one transition metal. Examples of the positive active material may include, but are not limited to, a lithium transition metal composite oxide, and a lithium-containing transition metal phosphate compound.

In some embodiments, transition metals in the lithium transition metal composite oxide include V, Ti, Cr, Mn, Fe, Co, Ni, Cu, and the like. In some embodiments, the lithium transition metal composite oxides include lithium cobalt composite oxide such as LiCoO₂; lithium nickel composite oxide such as LiNiO₂; lithium manganese composite oxide such as LiMnO₂, LiMn₂O₄, and Li₂MnO₄; lithium nickel manganese cobalt composite oxide such as LiNi_{1/3}Mn_{1/3}Co_{1/3}O₂ and LiNi_{0.5}Mn_{0.3}Co_{0.2}O₂, where a part of transition metal atoms serving as a main body of the lithium transition metal composite oxides is substituted by other elements such as Na, K, B, F, Al, Ti, V, Cr, Mn, Fe, Co, Li, Ni, Cu, Zn, Mg, Ga, Zr, Si, Nb, Mo, Sn, and W. Examples of the lithium transition metal composite oxide may include, but are not limited to, LiNi_{0.5}Mn_{0.5}O₂, LiNi_{0.85}Co_{0.10}Al_{0.05}O₂, LiNi_{0.33}Co_{0.33}Mn_{0.33}O₂, LiNi_{0.45}Co_{0.10}Al_{0.45}O₂, LiMn_{1.8}Al_{0.2}O₄, LiMn_{1.5}Ni_{0.5}O₄, and the like. Examples of combinations of the lithium transition metal composite oxides include, but are not limited to, a combination of LiCoO₂ and LiMn₂O₄, where a part of Co in LiCoO₂ may be substituted by a transition metal.

In some embodiments, the transition metals in the lithium-containing transition metal phosphate compound include V, Ti, Cr, Mn, Fe, Co, Ni, Cu, and the like. In some embodiments, the lithium-containing transition metal phosphate compounds include iron phosphate compounds such as LiFePO₄, Li₃Fe₂ (PO₄)₃, and LiFeP₂O₇; and cobalt phosphate compounds such as LiCoPO₄, where a part of transition metal atoms serving as a main body of the lithium transition metal phosphate compounds is substituted by other elements such as Al, Ti, V, Cr, Mn, Fe, Co, Li, Ni, Cu, Zn, Mg, Ga, Zr, Nb, and Si.

In some embodiments, the positive active material includes lithium phosphate, which can improve continuous charging performance of the electrochemical apparatus. The use of the lithium phosphate is not limited. In some embodiments, the positive active material is mixed with the lithium phosphate. In some embodiments, based on the mass of the positive active material and the lithium phosphate, the content of the lithium phosphate is greater than 0.1%, greater than 0.3%, or greater than 0.5%. In some embodiments, based on the mass of the positive active material and the lithium phosphate, the content of the lithium phosphate is less than 10%, less than 8%, or less than 5%. In some embodiments, the content of the lithium phosphate is within a range formed by any two of the foregoing values.

A material different from the composition of the positive active material may be attached to a surface of the positive active material. Examples of materials attached to the surface may include, but are not limited to: oxides such as aluminum oxide, silicon dioxide, titanium dioxide, zirconium oxide, magnesium oxide, calcium oxide, boron oxide, antimony oxide, and bismuth oxide; sulfates such as lithium sulfate, sodium sulfate, potassium sulfate, magnesium sulfate, calcium sulfate, and aluminum sulfate; carbonates such as lithium carbonate, calcium carbonate, and magnesium carbonate; carbon; and the like.

Such a surface-attached material may be attached to the surface of the positive active material by the following methods: (i) a method for dissolving or suspending the surface-attached material in a solvent to penetrate into the positive electrode active material and drying; (ii) a method for dissolving or suspending the precursor of the surface-attached material in a solvent to penetrate into the positive electrode active material, and reacting by heating or the like; or (iii) a method for adding the surface-attached material into a precursor of the positive active material, and sintering the material concurrently; or the like. In a case that carbon is attached to the surface, the attachment may also be implemented by mechanically attaching a carbon material (such as activated carbon) to the surface.

In some embodiments, based on the mass of the positive electrode mixture layer, the content of the material attached to the surface is greater than 0.1 ppm, greater than 1 ppm, or greater than 10 ppm. In some embodiments, based on the mass of the positive electrode mixture layer, the content of the material attached to the surface is less than 10%, less than 5%, or less than 2%. In some embodiments, based on the mass of the positive electrode mixture layer, the content of the material attached to the surface falls within a range formed by any two of the above values.

The attachment of the material onto the surface of the positive active material can suppress oxidation reactions of the electrolyte solution on the surface of the positive active material, and increase the lifespan of the electrochemical apparatus. When the amount of the material attached to the surface is too small, the effect of the material is not fully exhibited. When the amount of the material attached to the surface is too large, the material will hinder movement of lithium ions, and thereby sometimes increase an electrical resistance.

In this application, the material whose composition is different from that of the positive active material, which is attached onto the surface of the positive active material, is also referred to as a “positive active material”.

In some embodiments, a shape of a particle of the positive active material includes, but is not limited to, a block shape, a polyhedron shape, a spherical shape, an elliptical spherical shape, a plate shape, a needle shape, a column shape, and the like. In some embodiments, particles of the positive active material include primary particles, secondary particles, or a combination thereof. In some embodiments, the primary particles may coalesce into the secondary particles.

In some embodiments, a tap density of the positive active material is greater than 0.5 g/cm³, greater than 0.8 g/cm³, or greater than 1.0 g/cm³. When the tap density of the positive active material falls within the above ranges, the amount of a dispersion medium required for formation of the positive electrode mixture layer, the required amount of the conductive material, and the required amount of the positive binder can be reduced, thereby ensuring a high packability of the positive active material and a high capacity of the electrochemical apparatus. A composite oxide powder with a high tap density can be used to form a high-density positive electrode mixture layer. Generally, the higher the tap density, the better, without being limited to a particular upper limit. In some embodiments, the tap density of the positive active material is less than 4.0 g/cm³, less than 3.7 g/cm³, or less than 3.5 g/cm³. When the tap density of the positive active material falls within the foregoing upper limit, deterioration of load characteristics can be suppressed.

The tap density of the positive active material may be determined by: putting 5 to 10 grams of the positive active material powder into a 10 mL glass graduated cylinder, and tapping the powder along a 20 mm stroke for 200 times to obtain a powder packing density (tap density).

When the particles of the positive active material are primary particles, a median particle size (D50) of the particles of the positive active material means a primary particle size of the particles of the positive active material. When the primary particles of the positive active material coalesce into secondary particles, the median particle size (D50) of the particles of the positive active material means a secondary particle size of the particles of the positive active material.

In some embodiments, the median particle size (D50) of the particles of the positive active material is greater than 0.3 μm, greater than 0.5 μm, greater than 0.8 μm, or greater than 1.0 μm. In some embodiments, the median particle size (D50) of the particles of the positive active material is less than 30 μm, less than 27 μm, less than 25 μm, or less than 22 μm. In some embodiments, the median particle size (D50) of the particles of the positive active material is within a range formed by any two of the foregoing values. When the median particle size (D50) of the particles of the positive active material falls within the foregoing ranges, a positive active material of a high tap density can be obtained, and performance degradation of the electrochemical apparatus can be suppressed. In addition, other problems such as occurrence of streaks can be prevented in a process of preparing the positive electrode of the electrochemical apparatus (the preparation process includes: mixing the positive active material, the conductive material, the binder, and the like with a solvent to form a slurry, and applying the slurry as a thin-film coating). In this way, packability of the positive active material during preparation of the positive electrode can be further increased by mixing of two or more types of positive active materials of different median particle sizes.

The median particle size (D50) of the particles of the positive active material can be measured with a laser diffraction/scattering particle size distribution analyzer. An exemplary measurement method includes: using a HORIBA LA-920 instrument as a particle size distribution analyzer, using a sodium hexametaphosphate aqueous solution of a 0.1% concentration as a dispersion medium for the measurement, ultrasonically dispersing the dispersion medium for 5 minutes, and then setting a measurement refractive index to 1.24 to determine the median particle size.

The type of the positive current collector is not particularly limited herein, and may be made of any material known as suitable for use in a positive current collector. Examples of the positive current collector may include, but are not limited to, metal materials such as aluminum, stainless steel, nickel plating, titanium, and tantalum; and carbon materials such as carbon cloth and carbon paper. In some embodiments, the positive current collector is made of a metal material. In some embodiments, the positive current collector is made of aluminum.

To reduce an electronic contact resistance of the positive current collector and the positive active material layer, a conductive agent may be contained on a surface of the positive current collector. Examples of the conductive agent may include, but are not limited to, carbon and noble metals such as gold, platinum, and silver.

A positive electrode may be prepared by forming a positive active material layer on a current collector, where the positive active material layer contains a positive active material and a binder. The positive electrode that contains a positive active material may be prepared by a conventional method. To be specific, the method may include: dry-mixing a positive active material, a binder, and, as appropriate, a conductive material and a thickener and the like, so as to form a sheet; and crimping the obtained sheet onto the positive current collector; or dissolving or dispersing such materials into a liquid medium to form a slurry, coating the positive current collector with the slurry, and drying to form a positive active material layer on the current collector, thereby obtaining a positive electrode.

### II. Electrolyte Solution

The electrochemical apparatus of this application further includes an electrolyte solution. The electrolyte solution includes an electrolyte, a solvent for dissolving the electrolyte, and an additive.

In some embodiments, the electrolyte solution described herein includes a compound containing a cyano group (—CN). The cyano-containing compound can form a high-performance protection film on the surface of the positive electrode to well stabilize the active metal in the positive active material, suppress the dissolution of the active metal, improve the safety performance of the electrochemical apparatus at high temperature and high pressure, and effectively suppress the voltage drop.

In some embodiments, based on the total mass of the electrolyte solution, the mass percentage of the cyano-containing compound is a %, satisfying: 0.1≤a≤15. In some embodiments, 0.5≤a≤10. In some embodiments, 1.0≤a≤8.0. In some embodiments, 3.0≤a≤5.0. In some embodiments, the mass percentage of the cyano-containing compound in the electrolyte solution is 0.1%, 0.5%, 1%, 3%, 5%, 8%, 10%, 12%, 15%, or a value falling within a range formed by any two thereof. When the mass percentage of the cyano-containing compound in the electrolyte solution falls within the above range, the safety of the electrochemical apparatus is further improved, and the voltage drop of the electrochemical apparatus is further reduced.

In some embodiments, F₁/a≥2. In some embodiments, F₁/a≥3. In some embodiments, F₁/a≥4. In some embodiments, F₁/a≥5. In some embodiments, F₁/a≥10. In some embodiments, F₁/a≥15. In some embodiments, F₁/a≥20. In some embodiments, the F₁/a ratio is 2, 5, 10, 15, 20, 25, 30, 35, 40, 45, 50, or a value falling within a range formed by any two thereof. When the cohesive force of the positive electrode mixture layer at the initial test temperature of 25° C. and the mass percentage of the cyano-containing compound in the electrolyte solution satisfy the above relationships, the safety of the electrochemical apparatus is further improved, and the voltage drop of the electrochemical apparatus is further reduced.

By controlling the ratio of the cohesive force (F₁ N/m) of the positive electrode mixture layer at 25° C. to the mass percentage (a %) of the cyano-containing compound in the electrolyte solution (the ratio is denoted as F₁/a) to fall within the above range, this application can effectively stabilize structural stability of the positive active material in a case of thermal runaway, and assists or accelerates the structural denaturation and viscosity reduction of the positive electrode mixture layer (for example, the mixture layer containing a heat-sensitive binder), thereby quickly obstructing the transport channels of electrons and improving the safety performance of the electrochemical apparatus. When the positive electrode mixture layer includes a heat-sensitive binder, during charging and discharging, the cyano-containing compound may interact with the heat-sensitive binder, thereby maintaining the interfacial stability of the positive active material, further improving the safety performance of the electrochemical apparatus, and effectively suppressing the voltage drop.

In some embodiments, the cyano-containing compound includes, but is not limited to, at least one of: succinonitrile, glutaronitrile, adiponitrile, 1,5-dicyanopentane, 1,6-dicyanohexane, tetramethyl succinonitrile, 2-methyl glutaronitrile, 2,4-dimethyl glutaronitrile, 2,2,4,4-tetramethyl glutaronitrile, 1,4-dicyanopentane, 1,2-dicyanobenzene, 1,3-dicyanobenzene, 1,4-dicyanobenzene, ethylene glycol bis(propionitrile) ether, 3,5-dioxa-pimelonitrile, 1,4-bis(cyanoethoxy) butane, diethylene glycol bis(2-cyanoethyl) ether, triethylene glycol bis(2-cyanoethyl) ether, tetraethylene glycol bis(2-cyanoethyl) ether, 1,3-bis(2-cyanoethoxy) propane, 1,4-bis(2-cyanoethoxy) butane, 1,5-bis(2-cyanoethoxy) pentane, ethylene glycol bis(4-cyanobutyl) ether, 1,4-dicyano-2-butene, 1,4-dicyano-2-methyl-2-butene, 1,4-dicyano-2-ethyl-2-butene, 1,4-dicyano-2,3-dimethyl-2-butene, 1,4-dicyano-2,3-diethyl-2-butene, 1,6-dicyano-3-hexene, 1,6-dicyano-2-methyl-3-hexene, 1,3,5-pentanetricarbonitrile, 1,2,3-propanetricarbonitrile, 1,3,6-hexanetricarbonitrile, 1,2,6-hexanetricarbonitrile, 1,2,3-tris(2-cyanoethoxy) propane, 1,2,4-tris(2-cyanoethoxy) butane, 1,1,1-tris(cyanoethoxymethylene) ethane, 1,1,1-tris(cyanoethoxymethylene) propane, 3-methyl-1,3,5-tris(cyanoethoxy) pentane, 1,2,7-tris(cyanoethoxy) heptane, 1,2,6-tris(cyanoethoxy) hexane, or 1,2,5-tris(cyanoethoxy) pentane.

The above cyano-containing compounds may be used alone or combined arbitrarily. If the electrolyte solution includes two or more cyano-containing compounds, the mass percentage of the cyano-containing compounds means an aggregate mass percentage of the two or more cyano-containing compounds.

In some embodiments, the cyano-containing compound includes at least two of: succinonitrile, adiponitrile, ethylene glycol bis(propionitrile) ether, 1,3,5-pentanetricarbonitrile, 1,3,6-hexanetricarbonitrile, 1,2,6-hexanetricarbonitrile, 1,2,3-tris(2-cyanoethoxy) propane, or 1,2,4-tris(2-cyanoethoxy) butane. In this case, such compounds further improve the safety performance of the electrochemical apparatus and reduces the voltage drop of the electrochemical apparatus.

In some embodiments, the electrolyte solution may further include other additives. The additives include at least one of: fluoroethylene carbonate, 1,3-propane sultone, ethylene sulfate, vinylene carbonate, 1-propyl phosphate cyclic anhydride, or lithium difluorophosphate. By using at least one of the above additives or using a plurality of the above additives in combination, a composite protection layer can be formed at the cathode electrolyte interphase to more effectively protect the cathode electrolyte interphase, thereby further optimizing the safety performance of the electrochemical apparatus and further reducing the voltage drop of the electrochemical apparatus.

In some embodiments, the electrolyte solution further includes any nonaqueous solvent known in the prior art for use as a solvent in the electrolyte solution.

In some embodiments, the nonaqueous solvent includes, but is not limited to, one or more of: cyclic carbonate, chain carbonate, cyclic carboxylate, chain carboxylate, cyclic ether, chain ether, a phosphorus-containing organic solvent, a sulfur-containing organic solvent, or an aromatic fluorine-containing solvent.

In some embodiments, examples of the cyclic carbonate may include, but are not limited to, one or more of: ethylene carbonate (EC), propylene carbonate (PC), or butylene carbonate. In some embodiments, the cyclic carbonate contains 3 to 6 carbon atoms.

In some embodiments, examples of the chain carbonate may include, but are not limited to, one or more of: dimethyl carbonate, ethyl methyl carbonate, diethyl carbonate (DEC), methyl n-propyl carbonate, ethyl n-propyl carbonate, di-n-propyl carbonate, or the like. Examples of a fluorinated chain carbonate may include, but are not limited to, one or more of: bis(fluoromethyl) carbonate, bis(difluoromethyl) carbonate, bis(trifluoromethyl) carbonate, bis(2-fluoroethyl) carbonate, bis(2,2-difluoroethyl) carbonate, bis(2,2,2-trifluoroethyl) carbonate, 2-fluoroethyl methyl carbonate, 2,2-difluoroethyl methyl carbonate, 2,2,2-trifluoroethyl methyl carbonate, or the like.

In some embodiments, examples of the cyclic carboxylate may include, but are not limited to, one or more of: gamma-butyrolactone and gamma-valerolactone. In some embodiments, a part of hydrogen atoms of the cyclic carboxylate may be substituted by fluorine.

In some embodiments, examples of the chain carboxylate may include, but are not limited to, one or more of: methyl acetate, ethyl acetate, propyl acetate, isopropyl acetate, butyl acetate, sec-butyl acetate, isobutyl acetate, tert-butyl acetate, methyl propionate, ethyl propionate, propyl propionate, isopropyl propionate, methyl butyrate, ethyl butyrate, propyl butyrate, methyl isobutyrate, ethyl isobutyrate, methyl valerate, ethyl valerate, methyl pivalate, ethyl pivalate, or the like. In some embodiments, a part of hydrogen atoms of the chain carboxylate may be substituted by fluorine. In some embodiments, examples of a fluorinated chain carboxylate may include, but are not limited to, methyl trifluoroacetate, ethyl trifluoroacetate, propyl trifluoroacetate, butyl trifluoroacetate, 2,2,2-trifluoroethyl trifluoroacetate, or the like.

In some embodiments, examples of the cyclic ether may include, but are not limited to, one or more of: tetrahydrofuran, 2-methyl tetrahydrofuran, 1,3-dioxolane, 2-methyl1,3-dioxolane, 4-methyl 1,3-dioxolane, 1,3-dioxane, 1,4-dioxane, or dimethoxypropane.

In some embodiments, examples of the chain ether may include, but are not limited to, one or more of: dimethoxymethane, 1,1-dimethoxyethane, 1,2-dimethoxyethane, diethoxymethane, 1,1-diethoxyethane, 1,2-diethoxyethane, ethoxymethoxymethane, 1,1-ethoxymethoxyethane, 1,2-ethoxymethoxyethane, or the like.

In some embodiments, examples of the phosphorus-containing organic solvent may include, but are not limited to, one or more of: trimethyl phosphate, triethyl phosphate, dimethyl ethyl phosphate, methyl diethyl phosphate, ethylene methyl phosphate, ethylene ethyl phosphate, triphenyl phosphate, trimethyl phosphite, triethyl phosphite, triphenyl phosphite, tris(2,2,2-trifluoroethyl)phosphate, tris(2,2,3,3,3-pentafluoropropyl) phosphate, or the like.

In some embodiments, examples of the sulfur-containing organic solvent may include, but are not limited to, one or more of: sulfolane, 2-methyl sulfolane, 3-methyl sulfolane, dimethyl sulfone, diethyl sulfone, ethyl methyl sulfone, methyl propyl sulfone, dimethyl sulfoxide, methyl methanesulfonate, ethyl methanesulfonate, methyl ethanesulfonate, ethyl ethanesulfonate, dimethyl sulfate, diethyl sulfate, or dibutyl sulfate. In some embodiments, a part of hydrogen atoms of the sulfur-containing organic solvent may be substituted by fluorine.

In some embodiments, the aromatic fluorine-containing solvent includes, but is not limited to, one or more of: fluorobenzene, difluorobenzene, trifluorobenzene, tetrafluorobenzene, pentafluorobenzene, hexafluorobenzene, or trifluoromethylbenzene.

In some embodiments, the solvent used in the electrolyte solution in this application includes cyclic carbonate, chain carbonate, cyclic carboxylate, chain carboxylate, and any combination thereof. In some embodiments, the solvent used in the electrolyte solution in this application includes an organic solvent containing a material selected from: ethylene carbonate, propylene carbonate, diethyl carbonate, ethyl propionate, propyl propionate, n-propyl acetate, ethyl acetate, or any combination thereof. In some embodiments, the solvent used in the electrolyte solution according to this application includes: ethylene carbonate, propylene carbonate, diethyl carbonate, ethyl propionate, propyl propionate, gamma-butyrolactone, and any combination thereof.

In some embodiments, the electrolyte is not particularly limited, and may be any material well-known for use as an electrolyte. In a case of a lithium secondary battery, a lithium salt is generally used as the electrolyte. Examples of the electrolyte may include, but are not limited to, inorganic lithium salts such as LiPF₆, LiBF₄, LiClO₄, LiAlF₄, LiSbF₆, and LiWF₇; lithium tungstate such as LiWOF₅, carboxylic lithium salts such as HCO₂Li, CH₃CO₂Li, CH₂FCO₂Li, CHF₂CO₂Li, CF₃CO₂Li, CF₃CH₂CO₂Li, CF₃CF₂CO₂Li, CF₃CF₂CF₂CO₂Li, and CF₃CF₂CF₂CF₂CO₂Li; lithium sulfonate salts such as FSO₃Li, CH₃SO₃Li, CH₂FSO₃Li, CHF₂SO₃Li, CF₃SO₃Li, CF₃CF₂SO₃Li, CF₃CF₂CF₂SO₃Li, and CF₃CF₂CF₂CF₂SO₃Li; lithium imide salts such as LiN(FCO)₂, LIN(FCO) (FSO₂), LIN(FSO₂)₂, LIN(FSO₂) (CF₃SO₂), LIN(CF₃SO₂)₂, LiN(C₂F₅SO₂)₂, cyclic lithium 1,2-perfluoroethane bissulfonimide, cyclic lithium 1,3-perfluoropropane bissulfonimide, and LiN(CF₃SO₂) (C₄F₉SO₂); methylated lithium salts such as LiC(FSO₂)₃, LiC(CF₃SO₂)₃, and LiC(C₂F₅SO₂)₃; (malonato) lithium borate salts such as lithium bis(malonato) borate, and lithium difluoro (malonato) borate; (malonato) lithium phosphate salts such as lithium tris(malonato) phosphate, lithium difluorobis(malonato) phosphate, and lithium tetrafluoro (malonato) phosphate; fluorine-containing organic lithium salts such as LiPF₄ (CF₃)₂, LiPF₄ (C₂F₅)₂, LiPF₄ (CF₃SO₂)₂, LiPF₄(C₂F₅SO₂)₂, LiBF₃CF₃, LiBF₃C₂F₅, LiBF₃C₃F₇, LiBF₂ (CF₃)₂, LiBF₂ (C₂F₅)₂, LiBF₂ (CF₃SO₂)₂, and LiBF₂ (C₂F₅SO₂)₂; (oxalato) lithium borate salts such as lithium difluoro (oxalato) borate and lithium bis(oxalato) borate; and (oxalato) lithium phosphate salts such as lithium tetrafluoro (oxalato) phosphate, lithium difluorobis(oxalato) phosphate, lithium tris(oxalato) phosphate, and the like.

In some embodiments, the electrolyte is selected from LiPF₆, LiSbF₆, FSO₃Li, CF₃SO₃Li, LIN(FSO₂)₂, LIN(FSO₂) (CF₃SO₂), LiN(CF₃SO₂)₂, LIN(C₂F₅SO₂)₂, cyclic lithium 1,2-perfluoroethane bissulfonimide, cyclic lithium 1,3-perfluoropropane bissulfonimide, LiC(FSO₂)₃, LiC(CF₃SO₂)₃, LiC(C₂F₅SO₂)₃, LiBF₃CF₃, LiBF₃C₂F₅, LiPF₃ (CF₃)₃, LiPF₃ (C₂F₅)₃, lithium difluoro (oxalato) borate, lithium bis(oxalato) borate, or lithium difluorobis(oxalato) phosphate. Such electrolytes improve the output power feature, high-rate charge-discharge feature, high-temperature storage feature, cycling feature, and the like of the electrochemical apparatus.

A content of the electrolyte is not particularly limited as long as effects of this application are not impaired. In some embodiments, a total molar concentration of lithium in the electrolyte solution is greater than 0.3 mol/L, greater than 0.4 mol/L, or greater than 0.5 mol/L. In some embodiments, the total molar concentration of lithium in the electrolyte solution is less than 3 mol/L, less than 2.5 mol/L, or less than 2.0 mol/L. In some embodiments, the total molar concentration of lithium in the electrolyte solution falls within a range formed by any two of the foregoing values. When the concentration of the electrolyte is within the foregoing ranges, lithium as charged particles will not be deficient, and a viscosity of the lithium will be in an appropriate range, thereby ensuring a high electrical conductivity easily.

When two or more types of electrolytes are in use, the electrolyte includes at least one salt selected from groups consisting of any of monofluorophosphate, borate, oxalate, or fluorosulfonate. In some embodiments, the electrolyte includes a salt selected from groups consisting of any of monofluorophosphate, oxalate, or fluorosulfonate. In some embodiments, the electrolyte includes a lithium salt. In some embodiments, based on the mass of the electrolyte, the content of the salt selected from the groups consisting of any of monofluorophosphate, borate, oxalate, or fluorosulfonate is greater than 0.01% or greater than 0.1%. In some embodiments, based on the mass of the electrolyte, the content of the salt selected from the groups consisting of any of monofluorophosphate, borate, oxalate, or fluorosulfonate is less than 20% or less than 10%. In some embodiments, the content of the salt selected from the groups consisting of any of monofluorophosphate, borate, oxalate, or fluorosulfonate is within a range formed by any two of the foregoing values.

In some embodiments, the electrolyte contains at least one material selected from groups consisting of any of monofluorophosphate, borate, oxalate, or fluorosulfonate, and a least one type of salt other than the material. The salt other than the material may be a lithium salt exemplified above. In some embodiments, the salt other than the material is LiPF₆, LIN(FSO₂) (CF₃SO₂), LiN(CF₃SO₂)₂, LiN(C₂F₅SO₂)₂, cyclic lithium 1,2-perfluoroethane bissulfonimide, cyclic lithium 1,3-perfluoropropane bissulfonimide, LiC(FSO₂)₃, LiC(CF₃SO₂)₃, LiC(C₂F₅SO₂)₃, LiBF₃CF₃, LiBF₃C₂F₅, LiPF₃ (CF₃)₃, or LiPF₃ (C₂F₅)₃. In some embodiments, the salt other than the material is LiPF₆.

In some embodiments, based on the mass of the electrolyte, the content of the salt other than the material is greater than 0.01% or greater than 0.1%. In some embodiments, based on the mass of the electrolyte, the content of the salt other than the material is less than 20%, less than 15%, or less than 10%. In some embodiments, the content of the salt other than the material is within a range formed by any two of the foregoing values. Added at a mass percentage specified above, the salt other than the material is conducive to balancing the conductivity and viscosity of the electrolyte solution.

### III. Negative Electrode

The negative electrode includes a negative current collector and a negative electrode mixture layer disposed on at least one surface of the negative current collector. The negative electrode mixture layer includes a negative active material. The negative electrode mixture layer may be one layer or a plurality of layers. Each layer in the plurality of negative active material layers may contain the same or different negative active materials. The negative active material is any material that enables reversible intercalation and deintercalation of metal ions such as lithium ions. In some embodiments, a chargeable capacity of the negative active material is greater than a discharge capacity of the positive active material, so as to prevent unexpected precipitation of lithium metal on the negative electrode during charging. Examples of the negative active material may include, but are not limited to, carbon materials such as natural graphite and artificial graphite; metals such as silicon (Si) and tin (Sn); oxides of metal elements such as Si and Sn; or the like. The negative active materials may be used alone or used in combination.

The current collector that retains the negative active material may be any well-known current collector. Examples of the negative current collector include, but are not limited to, a metal material such as aluminum, copper, nickel, stainless steel, and nickel-plated steel. In some embodiments, the negative current collector is copper.

When the negative current collector is made of a metal material, the form of the negative current collector may include, but is not limited to, a metal foil, a metal cylinder, a metal coil, a metal sheet, a metal thin film, a metal mesh, stamped metal, foamed metal, and the like. In some embodiments, the negative current collector is a metal thin film. In some embodiments, the negative current collector is a copper foil. In some embodiments, the negative current collector is a calendered copper foil prepared by a calendering method or an electrolytic copper foil prepared by an electrolytic method.

In some embodiments, the thickness of the negative current collector is greater than 1 μm or greater than 5 μm. In some embodiments, the thickness of the negative current collector is less than 100 μm or less than 50 μm. In some embodiments, the thickness of the negative current collector falls within a range formed by any two of the foregoing values.

The negative electrode mixture layer may include a negative binder. The negative binder can strengthen the bonding between the particles of the negative active material and the bonding between the negative active material and the current collector. The type of the negative binder is not particularly limited, as long as the material of the binder is stable to the electrolyte solution or the solvent used in manufacturing the electrode. In some embodiments, the negative binder includes a resin binder. Examples of the resin binder include, but are not limited to, fluororesin, polyacrylonitrile (PAN), polyimide resin, acrylic resin, polyolefin resin, and the like. When a negative electrode slurry is prepared from an aqueous solvent, the negative binder includes, but is not limited to, carboxymethyl cellulose (CMC) or a salt thereof, styrene-butadiene rubber (SBR), polyacrylic acid (PAA) or a salt thereof, polyvinyl alcohol, and the like.

The negative electrode may be prepared by the following method: coating a negative current collector with a negative electrode slurry that contains a negative active material, a resin binder, and the like; drying the slurry, and then calendering the current collector to form a negative electrode mixture layer on both sides of the negative current collector, thereby obtaining a negative electrode.

### IV. Separator

To prevent short circuits, a separator is generally disposed between the positive electrode and the negative electrode. In this case, the electrolyte solution of this application generally works by penetrating into the separator.

The material and shape of the separator are not particularly limited as long as they do not significantly impair the effects of this application. The material of the separator may be resin, glass fiber, an inorganic compound, or the like that is stable to the electrolyte solution of this application. In some embodiments, the separator contains a highly liquid-retaining porous sheet or non-woven fabric shaped material, and the like. Examples of resin or glass fiber used as the separator may include, but are not limited to, polyolefin, aramid, polytetrafluoroethylene, polyethersulfone, and the like. In some embodiments, the polyolefin is polyethylene or polypropylene. In some embodiments, the polyolefin is polypropylene. The foregoing separator materials may be used alone or combined arbitrarily.

The separator may also be made of a material that is formed by stacking the foregoing materials. Examples of such material include, but are not limited to, a three-layer separator formed by sequentially stacking polypropylene, polyethylene, and polypropylene.

Examples of the inorganic compound used as the material of the separator may include, but are not limited to, an oxide such as aluminum oxide and silicon dioxide; a nitride such as aluminum nitride and silicon nitride; and a sulfate salt (such as barium sulfate and calcium sulfate). The shape of the inorganic compound may include, but is not limited to a particle or fiber shape.

The form of the separator may be a thin film form. Examples include, but are not limited to, a non-woven fabric, a woven fabric, a microporous film, and the like. In a case that the separator is in a thin film form, a pore size of the separator is 0.01 μm to 1 μm, and a thickness of the separator is 5 μm to 50 μm. Other than the stand-alone separator described above, a separator made in the following way is also applicable: a separator made by forming a composite porous layer on the surface of the positive electrode and/or the negative electrode by using a resinous binder, where the composite porous layer contains the foregoing inorganic particles. For example, the separator is made by using a fluororesin as a binder so that aluminum oxide particles with a particle size D90 less than 1 μm form a porous layer on both sides of the positive electrode.

The thickness of the separator is arbitrary. In some embodiments, the thickness of the separator is greater than 1 μm, greater than 5 μm, or greater than 8 μm. In some embodiments, the thickness of the separator is less than 50 μm, less than 40 μm, or less than 30 μm. In some embodiments, the thickness of the separator is within a range formed by any two of the foregoing values. When the thickness of the separator falls within the foregoing ranges, high insulation and mechanical strength of the separator are ensured, and high rate performance and energy density of the electrochemical apparatus are ensured.

When a porous material such as a porous sheet or non-woven fabric is used as the separator, a porosity of the separator is arbitrary. In some embodiments, the porosity of the separator is greater than 10%, greater than 15%, or greater than 20%. In some embodiments, the porosity of the separator is less than 60%, less than 50%, or less than 45%. In some embodiments, the porosity of the separator is within a range formed by any two of the foregoing values. When the porosity of the separator falls within the foregoing ranges, high insulation and mechanical strength of the separator are ensured, a separator resistance can be suppressed, and high safety performance of the electrochemical apparatus is ensured.

An average pore size of the separator is also arbitrary. In some embodiments, the average pore size of the separator is less than 0.5 μm or less than 0.2 μm. In some embodiments, the average pore size of the separator is greater than 0.05 μm. In some embodiments, the average pore size of the separator is within a range formed by any two of the foregoing values. If the average pore size of the separator exceeds the foregoing ranges, a short circuit is likely to occur. When the average pore size of the separator falls within the foregoing ranges, high safety performance of the electrochemical apparatus is ensured.

### V. Components of the Electrochemical Apparatus

Components of the electrochemical apparatus include an electrode assembly, a current collection structure, an outer housing, and a protection element.

The electrode assembly may be a stacked structure formed by stacking the positive electrode and the negative electrode that are interspaced with the separator, or a jelly-roll structure formed by spirally winding the positive electrode and the negative electrode that are interspaced with the separator. In some embodiments, a percentage of a volume of the electrode assembly in a total volume inside a battery (hereinafter referred to as “electrode assembly volume percentage”) is greater than 40% or greater than 50%. In some embodiments, the electrode assembly volume percentage is less than 90% or less than 80%. In some embodiments, the electrode assembly volume percentage is within a range formed by any two of the foregoing values. When the electrode assembly volume percentage falls within the foregoing range, a high capacity of the electrochemical apparatus is ensured, and deterioration of performance such as charge and discharge cycle performance and high-temperature storage performance is suppressed, where the deterioration of performance is accompanied with an increase of an internal pressure.

The current collection structure is not particularly limited. In some embodiments, the current collection structure is a structure that reduces a resistance of a wiring part and a splicing part. When the electrode assembly is the foregoing stacked structure, it is appropriate to use a structure formed by bundling a metal core part of each electrode layer and welding the bundle to a terminal. When an area of an electrode plate increases, an internal resistance increases. Therefore, it is appropriate to configure at least 2 terminals in the electrode to reduce the resistance. When the electrode assembly is the jelly-roll structure, at least 2 wiring structures are disposed on the positive electrode and the negative electrode separately and are bundled on the terminals, thereby reducing the internal resistance.

The material of the outer housing is not particularly limited as long as the material is stable to the electrolyte solution in use. The material of the outer housing may be, but is not limited to, a metallic material such as nickel-plated steel, stainless steel, aluminum, aluminum alloy, magnesium alloy, or a laminated film of resin and an aluminum foil. In some embodiments, the outer housing is a metal or laminated film of aluminum or aluminum alloy.

The metallic outer housing includes, but is not limited to, a sealed airtight structure formed by fusing metals to each other by means of laser welding, resistance welding, or ultrasonic welding; or the metallic outer housing is a riveted structure formed by using such metals cushioned by a resin gasket. The outer housing made of the laminated film includes, but is not limited to, a sealed airtight structure formed by thermally bonding resin layers. To increase airtightness, the resin layers may be interspaced with a resin different from the resin used in the laminated film. When the airtight structure is formed by thermally bonding the resin layers through a current collection terminal, in view of the bonding between the metal and the resin, the resin between the resin layers may be a resin that contains a polar group or a modified resin into which a polar group is introduced. In addition, the shape of the outer housing is also arbitrary. For example, the outer housing may be any of the shapes such as a cylindrical shape, a square shape, a laminated shape, a button shape, and a bulk shape.

The protection element may be a positive temperature coefficient (PTC) thermistor, a temperature fuse, or a thermistor, which, in each case, increases a resistance when abnormal heat is emitted or an excessive current is passed; or may be a valve (a current cutoff valve) that cuts off the current in a circuit by rapidly increasing the internal pressure or internal temperature of the battery during abnormal heat emission, or the like. The protection element may be an element that remains idle during routine use under a high current, and may also be designed in a form that prevents abnormal heat radiation or thermal runaway even if no protection element exists.

The electrochemical apparatus of this application includes any apparatus in which an electrochemical reaction occurs. Specific examples of the electrochemical apparatus include a lithium metal secondary battery or a lithium-ion secondary battery.

This application further provides an electronic apparatus containing the electrochemical apparatus according to this application.

The uses of the electrochemical apparatus according to this application are not particularly limited, and the electrochemical apparatus may be used in any electronic apparatus known in the prior art. In some embodiments, the electrochemical apparatus according to this application is applicable to, but without being limited to, a notebook computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household battery, lithium-ion capacitor, and the like.

By using a lithium-ion battery as an example, the following describes a preparation method of a lithium-ion battery with reference to specific embodiments. A person skilled in the art understands that the preparation methods described in this application are merely examples, and any other appropriate preparation methods still fall within the scope of this application.

### Embodiments

### I. Preparing a Lithium-Ion Battery

### 1. Preparing a Negative Electrode

Mixing artificial graphite, styrene-butadiene rubber, and sodium carboxymethyl cellulose at a mass ratio of 96%:2%:2%, adding deionized water, and stirring well to obtain a slurry. Coating a 9 μm-thick copper foil with the slurry, drying the slurry, cold-pressing the foil, and then cutting the plate and welding tabs to obtain a negative electrode.

### 2. Preparing a Positive Electrode

Mixing lithium cobalt oxide, Super-P, and a binder at a mass ratio of 96.5:2:1.5, mixing the mixture with N-methyl-pyrrolidone (NMP), and stirring well to obtain a positive electrode slurry. Coating a 12 μm-thick aluminum foil with the positive electrode slurry, drying the slurry, cold-pressing the foil, cutting the electrode plate, and welding tabs to obtain a positive electrode.

In the following embodiments, if the content of the binder is adjusted, then the content of the conductive agent is maintained at 2%, and the remainder is lithium cobalt oxide.

The binders in use are shown in the following table:

| Serial | |
|---|---|
| number | Binder and content |
| B1 | 1% PVDF and 0.5% thermally expandable microspheres |
| | Matsumoto Microsphere F-30D |
| B2 | 1% PVDF and 0.5% thermally expandable microspheres |
| | Matsumoto Microsphere FN-100SSD |
| B3 | 1% PVDF and 0.5% thermally expandable microspheres |
| | Expancel 909-80 |
| B4 | 1% PVDF and 0.5% thermally expandable microspheres |
| | Expancel 930-120 |
| B5 | 1% PVDF and 0.5% thermally expandable microspheres |
| | DAIFOAM H750 |
| B6 | 1% PVDF and 0.5% thermally expandable microspheres |
| | DAIFOAM M520 |
| B7 | 1% PVDF and 0.5% thermally expandable microspheres |
| | ADVANCELL EHM302 |
| B8 | 1% PVDF and 0.5% thermally expandable microspheres |
| | ADVANCELL EM501 |
| B9 | 1.5% thermally expandable microspheres Matsumoto |
| D1 | Microsphere F-30D 1.5% PVDF |

### 3. Preparing an Electrolyte Solution

Mixing EC, PP, and DEC at a mass ratio of 1:1:1 in a dry argon atmosphere, adding LiPF₆, and stirring well to form a base electrolyte solution in which the concentration of LiPF₆ is 12.5%. As required, adding additives at different mass percentages into the base electrolyte solution to obtain the electrolyte solutions for different embodiments and comparative embodiments.

The abbreviations and full names of constituents in the electrolyte solution are shown in the following table:

| Material name | Abbreviation | Material name | Abbreviation |
|---|---|---|---|
| Ethylene carbonate | EC | Propyl propionate | PP |
| Diethyl carbonate | DEC | Fluoroethylene | FEC |
| | | carbonate | |
| Succinonitrile | SN | Adiponitrile | ADN |
| Ethylene glycol bis(2- | EDN | 1,3,6- | HTCN |
| cyanoethyl)ether | | hexanetricarbonitrile | |
| 1,2,3-tris(2- | TCEP | 1,3-propane sultone | PS |
| cyanoethoxy)propane | | | |
| Lithium | LiDFP | Ethylene sulfate | DTD |
| difluorophosphate | | | |
| Vinylene carbonate | VC | 1-propyl phosphate | T3P |
| | | cyclic anhydride | |

### 4. Preparing a Separator

Using a polyethylene (PE) porous polymer film as a separator for each embodiment and Comparative Embodiment 1-1.

Using a polyethylene (PE) porous polymer film, coated with a binder on both sides, as a separator for Comparative Embodiment 1-2.

### 5. Preparing a Lithium-Ion Battery

A preparation method includes: sequentially winding the obtained positive electrode, separator, and negative electrode, putting them into an outer package foil, and leaving an injection hole; Injecting the electrolyte solution through the injection hole, and performing the steps such as sealing, chemical formation, and capacity grading to obtain a lithium-ion battery.

### II. Test Methods

According to the above preparation method, a batch of lithium-ion batteries are prepared for each embodiment and each comparative embodiment. A part of the lithium-ion batteries are disassembled to test the cohesive force of the positive electrode mixture layer, and the remaining lithium-ion batteries are subjected to the tests of a high-temperature short-circuit deformation rate, an overcharge deformation rate, and a voltage drop. The average value of the test data is used as the test result.

### 1. Method for Testing the Cohesive Force of the Positive Electrode Mixture Layer

Disassembling a lithium-ion battery to take out a positive electrode plate. Selecting a single-side coated electrode plate (or scraping off the active material from one side of a double-side coated electrode plate by use of a scraper to obtain a single-side coated electrode plate), and cutting the electrode plate into specimens of 100 mm in length and 10 mm in width. Taking a stainless steel sheet 25 mm wide, affixing the specimen onto the stainless steel sheet by use of 3M double-sided tape (11 mm wide), and bonding the current collector to the double-sided tape. Using a 2000 g pressure roller to roll on the surface of the specimen back and forth for three times (at a speed of 300 mm/min). Subsequently, affixing an adhesive tape of 10 mm in width and 50 μm in thickness (model: NITTO.NO5000NS) onto the surface of the active material layer, and using a 2000 g pressure roller to roll on the surface of the specimen back and forth for three times (at a speed of 300 mm/min). Bending the adhesive tape by 180 degrees, manually peeling off the adhesive tape from the active material layer by 25 mm apart, fixing the specimen on an Instron 336 tensile testing machine, keeping the peeling surface in line with the force line of the testing machine (that is, peeling at 180°), and keeping peeling off the adhesive tape continuously at a speed of 300 mm/min to obtain a cohesive force curve. Taking an average value in a steady segment as the peel force F₀, and calculating the cohesive force F₁ of the electrode plate specimen as: F₁=F₀/specimen width, where F₁ is in units of N/m.

### 2. Testing a High-Temperature Short-Circuit Deformation Rate of the Lithium-Ion Battery

The determining method includes: leaving the lithium-ion battery to stand for 30 minutes at a temperature of 25° C., charging the battery at a constant current of 0.5 C—rate until the voltage reaches 4.7 V, charging the battery at a constant voltage of 4.7 V until the current reaches 0.05 C, leaving the battery to stand for 60 minutes, and measuring a thickness T1 of the lithium-ion battery; and Subsequently, short-circuiting the battery for 10 seconds by using a resistance of 100 mΩ, and then measuring the thickness T2 of the lithium-ion battery. Calculating the high-temperature short-circuit deformation rate of the lithium-ion battery as:

$$short - circuit deformation rate = [ ( {T}_{2} - {T}_{1} ) / {T}_{1} ] \times 100 \% .$$

### 3. Testing an Overcharge Deformation Rate of the Lithium-Ion Battery

Leaving a lithium-ion battery to stand at 25° C. for 30 minutes, and then charging the battery at a constant current rate of 0.5C until the voltage reaches 4.7 V, charging the battery at a constant voltage of 4.7 V until the current drops to 0.05C, leaving the battery to stand for 60 minutes, and measuring a thickness T3 of the lithium-ion battery. Charging the battery at a constant current of 0.1 C-rate for 60 minutes and leaving the battery to stand for 30 minutes; repeating this process for 5 times so that a state of charge (SOC) of the lithium-ion battery reaches 150%; and measuring the thickness T4 of the lithium-ion battery: Calculating the overcharge deformation rate of the lithium-ion battery as:

$$overcharge deformation rate = [ ( {T}_{4} - {T}_{3} ) / {T}_{3} ] \times 100 \% .$$

### 4. Testing the Voltage Drop of the Lithium-Ion Battery

Charging a lithium-ion battery at 25° C. and a constant current of 1C until the voltage reaches 4.7 V, and then charging the battery at a constant voltage until the current drops to 0.05C, discharging the battery at a constant current of 1C until the voltage reaches 3.2 V, leaving the battery to stand for 5 minutes, and then measuring the voltage (pre-storage voltage). Storing the lithium-ion battery at 85° C. for 24 hours, and measuring the voltage (post-storage voltage) again. Calculating the voltage drop of the lithium-ion battery as:

$$voltage drop = pre - storage voltage - post - storage voltage .$$

### III. Test Results

Table 1 shows how the cohesive force of the positive electrode mixture layer affects the safety performance of the electrochemical apparatus at high temperature and high pressure and the voltage drop of the electrochemical apparatus stored at high temperature, where the electrolyte solution used is the base electrolyte solution.

TABLE 1

| | | | | | Over- | Short- | |
|---|---|---|---|---|---|---|---|
| | | | | | charge | circuit | Volt- |
| | | | | | defor- | defor- | age |
| | Bind- | | | F₁/ | mation | mation | drop |
| | er | F₁ | F₂ | F₂ | rate (%) | rate (%) | (V) |
| Embodiment 1-1 | B1 | 30 | 6 | 5 | 16.8 | 15.3 | 0.39 |
| Embodiment 1-2 | B2 | 40 | 6 | 6.7 | 15.6 | 15.2 | 0.37 |
| Embodiment 1-3 | B3 | 50 | 5 | 10 | 14.3 | 14.9 | 0.35 |
| Embodiment 1-4 | B4 | 60 | 5 | 12 | 12.7 | 14.3 | 0.34 |
| Embodiment 1-5 | B5 | 70 | 2 | 35 | 11.9 | 13.7 | 0.32 |
| Embodiment 1-6 | B6 | 80 | 2 | 40 | 11.5 | 13.5 | 0.31 |
| Embodiment 1-7 | B7 | 80 | 1 | 80 | 10.2 | 12.2 | 0.26 |
| Embodiment 1-8 | B8 | 80 | 5 | 16 | 12.9 | 13.1 | 0.29 |
| Embodiment 1-9 | B9 | 100 | 2 | 50 | 10.7 | 11.6 | 0.23 |
| Comparative | D1 | 30 | 15 | 2 | 46.9 | 39.7 | 0.78 |
| Embodiment 1-1 | | | | | | | |
| Comparative | B1 | 30 | 15 | 2 | 34.5 | 39.3 | 0.97 |
| Embodiment 1-2 | | | | | | | |

As can be seen from Embodiments 1-1 to 1-9 versus Comparative Embodiment 1-1, when the cohesive force of the positive electrode mixture layer is controlled to satisfy F₁/F₂≥5, the overcharge deformation rate, short-circuit deformation rate, and voltage drop of the electrochemical apparatus of Embodiments 1-1 to 1-9 at high temperature and high pressure are reduced significantly.

In Comparative Embodiment 1-2 and Embodiment 1-1, the same heat-sensitive binder is used, but the position at which the binder is applied is different. The heat-sensitive binder in Comparative Embodiment 1-2 is applied on the separator while the heat-sensitive binder in Embodiment 1-1 is added in the positive electrode mixture layer. The results show that the effect of improving the safety and reducing the voltage drop of the electrochemical apparatus when the heat-sensitive binder is applied onto the separator of the electrochemical apparatus is far lower than the effect achieved when the same heat-sensitive binder is applied onto the positive electrode mixture layer. That is because in a case that the heat-sensitive binder is applied onto the separator, when the positive electrode of the battery is thermally runaway (especially when a short circuit occurs), the heat-sensitive binder on the separator is unable to quickly absorb heat in time, thereby being unable to effectively improve the safety of the electrochemical apparatus. In an embodiment of this application, the heat-sensitive binder is located in the positive electrode mixture layer, thereby being able to respond promptly to the heat released in a case of thermal runaway, and improving the safety performance significantly. In addition, unexpectedly, the crystal form structure of the heat-sensitive binder of this application is partially transformed at high temperature (60° C. to 100° C.), thereby further increasing the viscosity of the binder, enhancing the stability of the mixture layer, and reducing the internal resistance of the battery, and in turn, effectively reducing the voltage drop of the electrochemical apparatus stored at high temperature.

Table 2 shows how the content of the heat-sensitive binder in the positive electrode mixture layer affects the safety performance of the electrochemical apparatus at high temperature and high pressure and the voltage drop of the electrochemical apparatus stored at high temperature. Embodiment 2-1 differs from Embodiment 1-2 in only the parameters set out in Table 2; Embodiments 2-2 to 2-7 differ from Embodiment 1-1 in only the parameters set out in Table 2.

As shown in Table 2, when the content of the heat-sensitive binder in the positive electrode mixture layer is 0.5% to 5%, the lithium-ion battery exhibits excellent safety performance and a relatively low voltage drop at high temperature and high pressure. In particular, when the content of the heat-sensitive binder in the positive electrode mixture layer is 0.5% to 2%, the effect in improving the safety performance and reducing the voltage drop of the lithium-ion battery is particularly significant.

TABLE 2

| | | | Overcharge | Short-circuit | |
|---|---|---|---|---|---|
| | | | deformation | deformation | Voltage |
| | x | F₁/F₂ | rate (%) | rate (%) | drop (V) |
| Embodiment 1-1 | 0.5 | 5 | 16.8 | 15.3 | 0.39 |
| Embodiment 1-2 | 0.5 | 6.7 | 15.6 | 15.2 | 0.37 |
| Embodiment 2-1 | 0.4 | 5 | 18.5 | 16.7 | 0.41 |
| Embodiment 2-2 | 1 | 20 | 11.8 | 11.1 | 0.21 |
| Embodiment 2-3 | 1.5 | 30 | 12.2 | 10.8 | 0.25 |
| Embodiment 2-4 | 2 | 40 | 12.7 | 12.9 | 0.35 |
| Embodiment 2-5 | 3 | 50 | 15.9 | 15.1 | 0.37 |
| Embodiment 2-6 | 5 | 50 | 16.2 | 15.7 | 0.45 |
| Embodiment 2-7 | 6 | 50 | 16.9 | 16.2 | 0.48 |

Table 3 shows how the additives in the electrolyte solution affect the safety performance of the electrochemical apparatus at high temperature and high pressure and the voltage drop of the electrochemical apparatus stored at high temperature. Embodiments 3-1 to 3-29 differ from Embodiment 1-1 in only the type and content of the additives in the electrolyte solution, as detailed in Table 3.

TABLE 3

| | | | Overcharge | Short-circuit | |
|---|---|---|---|---|---|
| | Additive in electrolyte solution | | deformation | deformation | Voltage |
| | (content %) | F₁/a | rate (%) | rate (%) | drop (V) |
| 1-1 | / | / | 16.8 | 15.3 | 0.39 |
| 3-1 | SN (3) | 10 | 13.4 | 12.9 | 0.21 |
| 3-2 | ADN (3) | 10 | 13 | 12.4 | 0.19 |
| 3-3 | EDN (3) | 10 | 12.7 | 12.3 | 0.18 |
| 3-4 | HTCN (3) | 10 | 12.1 | 11.5 | 0.17 |
| 3-5 | TCEP (3) | 10 | 11.3 | 11.1 | 0.16 |
| 3-6 | SN (1) + ADN (2) | 10 | 11.1 | 9.5 | 0.15 |
| 3-7 | SN (2) + EDN (1) | 10 | 10.6 | 9.3 | 0.14 |
| 3-8 | SN (2) + HTCN (1) | 10 | 10.3 | 9.1 | 0.13 |
| 3-9 | SN (2) + TCEP (1) | 10 | 10.1 | 8.5 | 0.12 |
| 3-10 | ADN (2) + EDN (1) | 10 | 10.9 | 9.4 | 0.15 |
| 3-11 | ADN (2) + HTCN (1) | 10 | 9.6 | 8.7 | 0.13 |
| 3-12 | ADN (2) + EDN (1) + HTCN (1) | 7.5 | 9.3 | 8.2 | 0.12 |
| 3-13 | ADN (2) + EDN (1) + TCEP (1) | 7.5 | 9.1 | 7.9 | 0.11 |
| 3-14 | ADN (2) + HTCN (1) + TCEP (1) | 7.5 | 8.5 | 7.5 | 0.12 |
| 3-15 | ADN (2) + LiDFP (0.5) | 15 | 11.6 | 8.8 | 0.13 |
| 3-16 | HTCN (2) + LiDFP (0.5) | 15 | 11.2 | 8.6 | 0.11 |
| 3-17 | TCEP (2) + LiDFP (0.5) | 15 | 10.2 | 8.3 | 0.12 |
| 3-18 | ADN (2) + EDN (1) + LiDFP (0.5) | 10 | 9.4 | 8.1 | 0.11 |
| 3-19 | ADN (2) + HTCN (1) + LiDFP (0.5) | 10 | 8.5 | 7.3 | 0.1 |
| 3-20 | SN (9) + ADN (6) | 2 | 11.6 | 11.2 | 0.19 |
| 3-21 | EDN (2) + HTCN (1) + FEC (4) | 10 | 8.3 | 7.7 | 0.11 |
| 3-22 | SN (3) + HTCN (1) + PS (1) | 7.5 | 8.9 | 7.4 | 0.12 |
| 3-23 | EDN (2) + FEC (4) + DTD (0.5) | 15 | 9.2 | 8.1 | 0.15 |
| 3-24 | ADN (3) + FEC (4) + T3P (0.5) | 10 | 7.8 | 6.7 | 0.16 |
| 3-25 | ADN (3) + HTCN (1) + VC (0.5) | 7.5 | 8.1 | 7.6 | 0.12 |
| 3-26 | ADN (3) + FEC (4) + VC (0.5) | 10 | 8.7 | 7.8 | 0.13 |
| 3-27 | HTCN (1) + FEC (4) + VC (0.5) | 30 | 8.2 | 7.1 | 0.12 |
| 3-28 | TCEP (1) + FEC (4) + VC (0.5) | 30 | 7.8 | 6.3 | 0.08 |
| 3-29 | SN (10) + ADN (8) | 1.7 | 16.2 | 14.9 | 0.22 |

As shown in Table 3, in contrast to Embodiment 1-1, a cyano-containing compound is further added in Embodiments 3-1 to 3-5. The results show that, when the cyano-containing compound is added in the electrolyte solution, the cyano-containing compound can further reduce the overcharge deformation rate and the short-circuit deformation rate of the electrochemical apparatus, and further suppress the voltage drop of the electrochemical apparatus stored at high temperature.

In addition, as can be seen from Embodiments 3-6 to 3-14 versus Embodiments 3-1 to 3-5, when at least two cyano-containing compounds are added in the electrolyte solution, the cyano-containing compounds can further reduce the overcharge deformation rate and the short-circuit deformation rate of the electrochemical apparatus, and further suppress the voltage drop of the electrochemical apparatus stored at high temperature.

As can be seen from Embodiment 3-29 versus Embodiments 3-6 and 3-20, with the same types of cyano-containing compounds added in the electrolyte solution, when F₁/a≥2, the safety performance and voltage drop of the electrochemical apparatus are further optimized.

Referring to Embodiments 3-15 to 3-19 and 3-21 to 3-28 in Table 3, when at least one of fluoroethylene carbonate, 1,3-propane sultone, ethylene sulfate, vinylene carbonate, or 1-propyl phosphate cyclic anhydride is further added in the electrolyte solution, the resulting electrochemical apparatus exhibits extraordinarily excellent safety performance at high temperature and high pressure and an excellent voltage drop in high-temperature storage.

References to “embodiments”, “some embodiments”, “an embodiment”, “another example”, “example”, “specific example” or “some examples” throughout the specification mean that specified features, structures, materials, or characteristics described in such embodiment(s) or example(s) are included in at least one embodiment or example in this application. Therefore, descriptions throughout the specification, which make references by using expressions such as “in some embodiments”, “in an embodiment”, “in one embodiment”, “in another example”, “in an example”, “in a specific example”, or “example”, do not necessarily refer to the same embodiment(s) or example(s) in this application. In addition, specific features, structures, materials, or characteristics herein may be combined in one or more embodiments or examples in any appropriate manner.

Although illustrative embodiments have been demonstrated and described above, a person skilled in the art understands that the foregoing embodiments are never to be construed as a limitation on this application, and changes, replacements, and modifications may be made to the embodiments without departing from the spirit, principles, and scope of this application.

What is claimed is:

1. An electrochemical apparatus, comprising a positive electrode, wherein the positive electrode comprises a positive current collector and a positive electrode mixture layer formed on at least one surface of the positive current collector; wherein
a cohesive force of the positive electrode mixture layer at an initial test temperature of 25° C. is F₁ N/m, and a cohesive force of the positive electrode mixture layer treated at 130° C. and then cooled to 25° C. is F₂ N/m, wherein F₁/F₂≥5.

2. The electrochemical apparatus according to claim 1, wherein 30≤F₁≤100.

3. The electrochemical apparatus according to claim 1, wherein the positive electrode mixture layer comprises a heat-sensitive binder.

4. The electrochemical apparatus according to claim 3, wherein the heat-sensitive binder is thermally expandable microspheres.

5. The electrochemical apparatus according to claim 3, wherein, when the temperature is in a range of 130° C. to 150° C., a viscosity of the heat-sensitive binder decreases with increase of the temperature.

6. The electrochemical apparatus according to claim 3, wherein, based on a total mass of the positive electrode mixture layer, a mass percentage of the heat-sensitive binder is x %, and
$$0.5 \leq x \leq 5.$$

7. The electrochemical apparatus according to claim 1, wherein the electrochemical apparatus further comprises an electrolyte solution, and the electrolyte solution comprises a cyano-containing compound.

8. The electrochemical apparatus according to claim 7, wherein, based on a total mass of the electrolyte solution, a mass percentage of the cyano-containing compound is a %, and 0.1≤a≤15.

9. The electrochemical apparatus according to claim 8, wherein F₁/a≥2.

10. The electrochemical apparatus according to claim 7, wherein the cyano-containing compound comprises at least one selected from the group consisting of: succinonitrile, glutaronitrile, adiponitrile, 1,5-dicyanopentane, 1,6-dicyanohexane, tetramethyl succinonitrile, 2-methyl glutaronitrile, 2,4-dimethyl glutaronitrile, 2,2,4,4-tetramethyl glutaronitrile, 1,4-dicyanopentane, 1,2-dicyanobenzene, 1,3-dicyanobenzene, 1,4-dicyanobenzene, ethylene glycol bis(propionitrile) ether, 3,5-dioxa-pimelonitrile, 1,4-bis(cyanoethoxy) butane, diethylene glycol bis(2-cyanoethyl) ether, triethylene glycol bis(2-cyanoethyl) ether, tetraethylene glycol bis(2-cyanoethyl) ether, 1,3-bis(2-cyanoethoxy) propane, 1,4-bis(2-cyanoethoxy) butane, 1,5-bis(2-cyanoethoxy) pentane, ethylene glycol bis(4-cyanobutyl) ether, 1,4-dicyano-2-butene, 1,4-dicyano-2-methyl-2-butene, 1,4-dicyano-2-ethyl-2-butene, 1,4-dicyano-2,3-dimethyl-2-butene, 1,4-dicyano-2,3-diethyl-2-butene, 1,6-dicyano-3-hexene, 1,6-dicyano-2-methyl-3-hexene, 1,3,5-pentanetricarbonitrile, 1,2,3-propanetricarbonitrile, 1,3,6-hexanetricarbonitrile, 1,2,6-hexanetricarbonitrile, 1,2,3-tris(2-cyanoethoxy) propane, 1,2,4-tris(2-cyanoethoxy) butane, 1,1,1-tris(cyanoethoxymethylene) ethane, 1,1,1-tris(cyanoethoxymethylene) propane, 3-methyl-1,3,5-tris(cyanoethoxy) pentane, 1,2,7-tris(cyanoethoxy) heptane, 1,2,6-tris(cyanoethoxy) hexane, and 1,2,5-tris(cyanoethoxy) pentane.

11. The electrochemical apparatus according to claim 7, wherein the cyano-containing compound comprises at least two selected from the group consisting of: succinonitrile, adiponitrile, ethylene glycol bis(propionitrile) ether, 1,3,5-pentanetricarbonitrile, 1,3,6-hexanetricarbonitrile, 1,2,6-hexanetricarbonitrile, 1,2,3-tris(2-cyanoethoxy) propane, and 1,2,4-tris(2-cyanoethoxy) butane.

12. The electrochemical apparatus according to claim 1, wherein the electrochemical apparatus further comprises an electrolyte solution; and the electrolyte solution comprises at least one selected from the group consisting of: fluoroethylene carbonate, 1,3-propane sultone, ethylene sulfate, vinylene carbonate, 1-propyl phosphate cyclic anhydride, and lithium difluorophosphate.

13. An electronic apparatus, comprising an electrochemical apparatus, the electrochemical apparatus comprises a positive electrode, wherein the positive electrode comprises a positive current collector and a positive electrode mixture layer formed on at least one surface of the positive current collector; wherein
a cohesive force of the positive electrode mixture layer at an initial test temperature of 25° C. is F₁ N/m, and a cohesive force of the positive electrode mixture layer treated at 130° C. and then cooled to 25° C. is F₂ N/m, wherein F₁/F₂≥5.

14. The electronic apparatus according to claim 13, wherein 30≤F₁≤100.

15. The electronic apparatus according to claim 13, wherein the positive electrode mixture layer comprises a heat-sensitive binder.

16. The electronic apparatus according to claim 15, wherein the heat-sensitive binder is thermally expandable microspheres.

17. The electronic apparatus according to claim 15, wherein, when the temperature is in a range of 130° C. to 150° C., a viscosity of the heat-sensitive binder decreases with increase of the temperature.

18. The electronic apparatus according to claim 15, wherein, based on a total mass of the positive electrode mixture layer, a mass percentage of the heat-sensitive binder is x %, and 0.5≤x≤5.

19. The electronic apparatus according to claim 13, wherein the electrochemical apparatus further comprises an electrolyte solution, and the electrolyte solution comprises a cyano-containing compound.

20. The electronic apparatus according to claim 19, wherein, based on a total mass of the electrolyte solution, a mass percentage of the cyano-containing compound is a %, and 0.1≤a≤15.
